(19) United States
(12) Patent Application Publication
(10) Pub. No.: US 2009/0091772 A1
(43) Pub. Date: Apr. 9, 2009

(54) PRINT SYSTEM, IMAGE DISPLAY APPARTUS, IMAGE DISPLAY METHOD, AND IMAGE DISPLAY PROGRAM

(75) Inventors: Ichiro Ujiie, Kanagawa (JP); Kohei Sakura, Kanagawa (JP); Kyoko Sugizaki, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/241,485

(22) Filed: Sep. 30, 2008

(30) Foreign Application Priority Data
Oct. 5, 2007 (JP) 2007-262658

(51) Int. Cl. H04N 1/60

(52) U.S. Cl. 358/1.9

(57) ABSTRACT

A print system for printing one printing image data in a plurality of printing sizes, includes an image display apparatus for displaying the printing image data, and a printer apparatus for printing the one printing image data which is displayed and selected with the image display apparatus in a plurality of printing sizes. The image display apparatus includes record means in which the printing image data is stored, display means for displaying the printing image data stored in the record means, and control means for causing the display means to simultaneously display frame data in the plurality of printing sizes on the selected printing image data.

### BACKGROUND OF THE INVENTION

1. Field of the Invention

The present invention relates to a print system, an image display apparatus, an image display method, and an image display program, in which one printing image data is printed in a plurality of different printing sizes.

2. Description of the Related Art

Print kiosk terminals which print printing image data captured with image capture apparatuses, such as a digital still camera, a mobile phone with a camera, etc., have been installed in a public place, such as a home appliance mass retailer, a station, a hotel, etc., and is widely used (see Japanese Patent Application Publication No. JP 2006-295236). A memory card brought by a user and having recorded thereon the printing image data is inserted into this type of print kiosk terminal, which reads the printing image data from the memory card to be displayed and listed at a monitor. The user selects printing image data to be printed from the printing image data which are displayed and listed on the monitor, and printing is performed.

This print kiosk terminal provides a printing method with which the one selected printing image data is printed in a plurality of different printing sizes. The user can print the one selected printing image data by this printing method in a plurality of different printing sizes, such as 3.5×5 inches, 4×6 inches, 5×7 inches, 6×8 inches, 8×10 inches etc.

However, each of such printing sizes has a different print area due to different in aspect ratio. Therefore, some area of the one selected printing image data may not be printed depending on the printing size.

In this case, in order to confirm the print area of respective printing size at which one selected printing image data is printed, it is necessary for the user to check with the monitor per printing size, thereby requiring times and efforts. Further, since a user checks with the monitor per each printing size, it is not easy to perceive print area relationships among different printing sizes etc.

### SUMMARY OF THE INVENTION

In view of such a related art situation, the present invention is made and provides a print system, an image display apparatus, an image display method, and an image display program, with which print areas of a plurality of printing sizes for printing one printing image data can be confirmed at a glance when one printing image data is printed in a plurality of printing sizes, and with which print area relationships among different printing sizes become also easy to perceive.

The print system in accordance with embodiments of the present invention prints one printing image data in a plurality of printing sizes, and includes an image display apparatus for displaying the printing image data and a printer apparatus for printing the one printing image data which is displayed and selected with the image display apparatus in a plurality of printing sizes. The image display apparatus includes record means in which the printing image data is stored, display means for displaying the printing image data stored in the record means, and control means for causing the display means to simultaneously display frame data in the plurality of printing sizes on the selected printing image data.

Further, the image display apparatus in accordance with embodiments of the present invention displays the one printing image data printed in the plurality of printing sizes by the printer apparatus, and includes the record means in which the printing image data is stored, the display means for displaying the printing image data stored in the record means, and the control means for causing the display means to simultaneously display the frame data in the plurality of printing sizes on the selected printing image data.

Furthermore, the image display method in accordance with embodiments of the present invention includes the steps of displaying the printing image data stored in the record means on the display means, and causing the display means to simultaneously display the frame data in the plurality of printing sizes on the selected printing image data.

The embodiments of the present invention as described above can be constituted by hardware, and also be realized by software. In other words, the image display computer program in accordance with embodiments of the present invention performs process of causing a control computer of the image display apparatus to display the printing image data stored in the record means on the display means, and causing the display means to simultaneously display the frame data in the plurality of printing sizes on the selected printing image data.

According to embodiments of the present invention, the printing image data stored in the record means can be displayed on the display means, and by causing the display means to simultaneously display the frame data in the plurality of printing sizes on the selected printing image data, it is possible to easily confirm the print areas in the plurality of printing sizes at which the one printing image data is printed, whereby the print area relationships among the different printing sizes can also be perceived easily.

Further, according to embodiments of the present invention, an edit process for the one printing image data can be carried out, while perceiving the print areas in the plurality of printing sizes at which the one printing image data is printed. Furthermore, according to embodiments of the present invention, the plurality of printing sizes at which the one printing image data is printed can be edited by performing the edit process for the one printing image data.

### BRIEF DESCRIPTION OF THE DRAWINGS

FIG. 1 is a perspective diagram showing a print system to which the present invention is applied;

FIG. 2 is a block diagram of the print system;

FIG. 3 is a view showing a media selection screen;

FIG. 4 is a view showing a printing menu screen;

FIG. 5 is a view showing a portrait content confirmation screen;

FIG. 6 is a view showing a printing image selection screen;

FIG. 7 is a view showing a printing image edit screen;

FIG. 8 is a view showing the printing image edit screen at the time of editing printing image data;

FIG. 9 is a view showing the printing image data. (A) shows the printing image data and (B) is a view showing a state where a plurality of print area frames are simultaneously displayed on the printing image data;

FIG. 10 is a view showing a photograph display part at the time the printing image data is enlarged;

FIG. 11 is a view showing the photograph display part at the time the print area frame is rotated; and

FIG. 12 is a view showing the photograph display part at the time the printing image data and the print area frame are rotated.

### DETAILED DESCRIPTION OF THE EMBODIMENTS

Hereafter, a print system in accordance with embodiments of the present invention will be described in detail with reference to the drawings.

This print system is installed in a public place, such as a station, a hotel, etc., and is used for a print kiosk terminal which provides services of printing the printing image data stored in a removable storage medium, such as a memory card brought by a user. Since a photograph is printed in this print system, a printer of a dye sublimation type thermal transfer system which is excellent in color reproduction is used for a printer apparatus of the system.

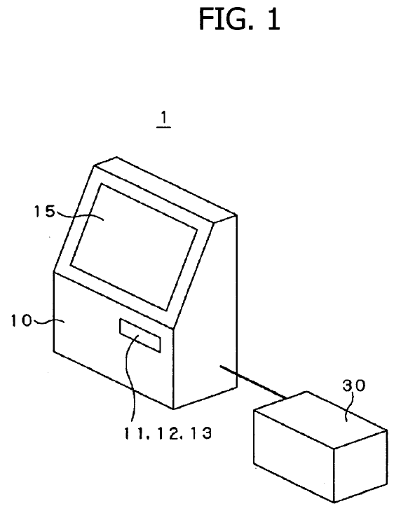

As shown in FIG. 1, a print system 1 to which the present invention is applied is provided with an image display apparatus 10 for displaying, selecting, and editing the printing image data, the printing image data being inputted from a removable recording medium, such as a memory card, and a printer apparatus 30 for printing the printing image data selected by the image display apparatus 10. For example, the image display apparatus 10 and the printer apparatus 30 are connected by a wire or wireless, and positioned adjacent to each other or incorporated in one casing.

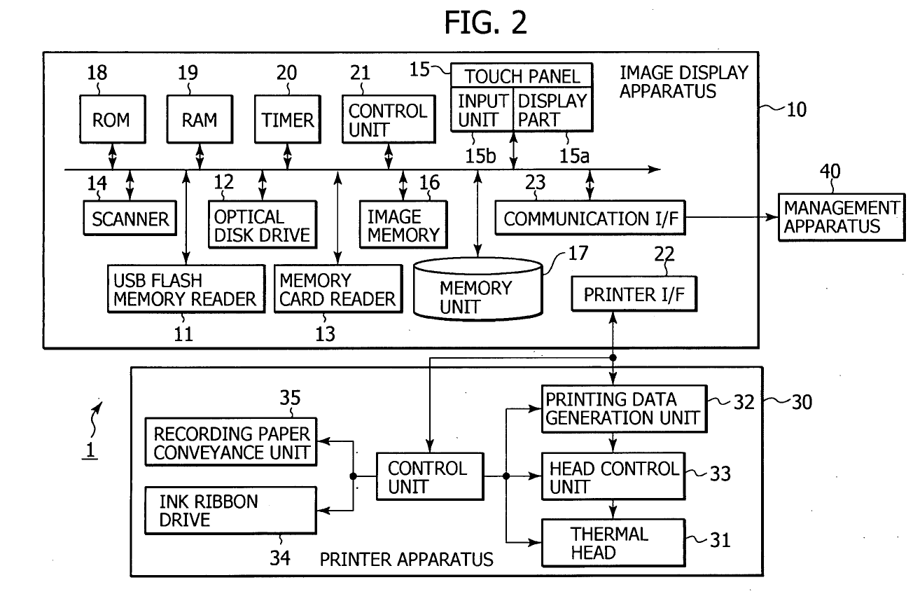

As shown in FIG. 2, the image display apparatus 10 which constitutes the print system 1 is provided with various drives for reading the removable recording medium brought by the user. In particular, the image display apparatus is provided with a USB flash memory I/F 11 in which a semiconductor memory, such as a flash memory, is used for a storage device to read the printing image data stored in the storage device by means of a USB (Universal Serial Bus) I/F, an optical disc drive 12 for reading the printing image data from optical discs, such as CD (Compact Disc) and DVD (Digital Versatile Disk), a memory card reader 13 for reading the printing image data stored in the storage device from the memory card in which a semiconductor memory, such as a flash memory, is used for the storage device, and a scanner 14 for optically reading the photograph brought by the user.

Further, this image display apparatus 10 is provided with a touch panel 15 which displays the printing image data inputted from the USB flash memory I/F 11, the optical disc drive 12, the memory card reader 13, and the scanner 14, and which is operated by the user, an image memory 16 for temporarily storing the printing image data to be displayed on the touch panel 15, a memory unit 17 which stores log data, such as the number of printing sheets and the number of times of use of templates, such as a frame provided in the periphery of the printing image data at the time of printing the image, a ROM 18 having stored therein a control program for controlling the entire operation, templates, such as a frame, for decorating the printing image data, a table of characters and symbols to be added to the printing image data, and a color table, a RAM 19 to which the control program and the templates, such as a selected frame, etc are temporally loaded, a timer 20 for timing predetermined time, and a control unit 21 for controlling the entire operation based on the control program or an operation signal inputted by the user.

Further, the image display apparatus 10 is provided with a printer I/F 22 for outputting the printing image data to be printed with the printer apparatus 30, and a communication I/F 23 for communicating with an external management apparatus 40 etc. through networks, such as the Internet.

The touch panel 15 is provided with a display unit 15a which displays the printing image data etc., and an input unit 15b which generates an operation signal when operated by the user. As a screen is touched with a finger or a dedicated pen, this touch panel 15 detects a position where the finger and the dedicated pen touches, specifies the position on the screen, and inputs the operation signal into the control unit 21. In particular, the touch panel detects changes in pressure, or detects an electric signal by static electricity to specify the position on the screen and generate the operation signal.

For example, a plurality of printing image data stored in a USB flash memory, an optical disc, a memory card, etc. are displayed on the touch panel 15 by using a thumbnail image, and one or a plurality of displayed thumbnail images are arranged in a selectable state. Further, as for the touch panel 15, a plurality of frames to be combined with the printing image data with respect to the selected thumbnail image or the character and character color to be added to the selected frame are arranged in selectable states.

The image memory 16 is a memory which stores the printing image data to be displayed on the touch panel 15. When, for example, processes of the selected printing image data, such as a zoom process, a process of moving the area for zooming, a process of rotating the printing image data, a process of adding text data, such as characters, a process of combining with the frame, etc. are carried out, the image memory 16 stores the printing image data after processing and outputs the data to the touch panel 15.

The memory unit 17 is constituted by a hard disc etc., and records the log data of printing etc. For example, the number of selections of the frames to be combined with the printing image data, the number of printing sheets, etc., are stored in the memory unit 17 as log data. These log data are transmitted to the management apparatus 40 so that an administrator can use the data as a reference to know popularity degree of templates, such as a frame, etc. Further, in the case where the user selects a template, such as a frame, the log data can be used so that the user displays the popular template preferentially on a template selection screen. Furthermore, the log data can also be stored in the removable recording medium mounted to the USB flash memory I/F 11, the optical disc drive 12, the memory card reader 13, etc. Still further, the memory unit 17 stores data of the print area with the printing size which can be printed with the printer apparatus 30, the frame, etc.

The ROM 18 is constituted by EP-ROM (Erasable Programmable Read-Only Memory) etc., and stores a browser for displaying the read printing image data by using a thumbnail image, a processing program for processing the printing image data, etc. Such various programs are read to the RAM 19 in response to the operation signal.

The timer 20 clocks time and predetermined time. For example, the timer 20 associates printing time etc. with the above-described log data so that the data are stored in the memory unit 17. Further, when counting the printing number of sheets and the number of times of selection within a predetermined time period, counting is performed for the predetermined time period, such as one month.

The control unit 21 is constituted of CPU etc. and performs a predetermined operation process following the computer program in accordance with the operation signal etc.

For example, if a predetermined unit image is selected with the touch panel 15, the control unit 21 turns the selected printing image data into a selection state, carries out a process of changing a display state. When process operation to the selected printing image data is performed, according to operation signal, the selected printing image data is subjected to the zoom process, the process of moving the area for zooming, the process of rotating the printing image data, the process of adding the text data, such as characters, the process of combining with the frame, etc.

The printer I/F 22 is connected with the printer apparatus 30 by a wire or wireless, and outputs the printing image data to be printed to the printer apparatus 30. Further, a communication I/F 23 is connected with the management apparatus 40 through networks, such as the Internet. For example, the communication I/F 23 transmits the log data stored in the memory unit 17 to the management apparatus 40 by following a predetermined protocol, such as TCP/IP.

The printer apparatus 30 connected with the image display apparatus 10 through the printer I/F 22 is provided with, as shown in FIG. 2, a thermal head 31 which sublimates a dye of an ink ribbon onto a regular paper etc., to form a color image, a printing data generation unit 32 for generating printing data to be printed from the printing image data inputted through the printer I/F 22 of the image display apparatus 10, a head control unit 33 for driving and controlling the thermal head 31, an ink ribbon drive 34 for causing the ink ribbon to travel, and a recording paper feeding unit 35 for conveying a recording paper.

In the thermal head 31, a plurality of exothermic elements are arranged linearly in the width direction of a rolled paper etc., and an exothermic element is supplied with drive current according to the printing data, so that the plurality of exothermic elements are selectively caused to generate heat. This thermal head 31 faces a platen, brings the ink ribbon into pressure contact with the recording paper, and supplies thermal energy from the ink ribbon side, to sublimate the dye etc. and transfer the dye to the recording paper.

The printing data generation unit 32 converts the printing image data to the printing data. In particular, the printing data generation unit 32 performs a color conversion process of converting the printing image data into YMC color space which represents an ink color, and performs predetermined processes, such as a gamma conversion process according to a coloring characteristic of the rolled paper.

According to the printing data generated in the printing data generation unit 32, the head control unit 33 generates a drive signal of the thermal head 31 and supplies the drive signal to the thermal head 31, to drive and control the thermal head 31 according to the printing image data. It should be noted that the process carried out in the printing data generation unit 32 may be performed by the image display apparatus 10 and the generated printing data may be outputted to the printer apparatus 30.

Further, the ink ribbon drive 34 causes an ink ribbon cartridge to run the ink ribbon wound in a supply reel and a rewinder reel. Here, in the ink ribbon, yellow, cyan, magenta, and a laminate film are frame sequentially arranged in this order in a running direction, so that a set of yellow, cyan, magenta, and the laminate film allows one photograph to be formed on the recording paper.

The recording paper feeding unit 35 has a conveyance roller, a plurality of driving rollers, etc., and conveys the recording papers, such as rolled paper, from a paper feed part to a paper ejection part through the thermal head 31. In order to form an image on the recording paper, it is necessary to transfer yellow, cyan, magenta, and the laminate film in this order. Thus, the recording paper feeding unit 35 causes the recording paper to travel synchronizing with the ink ribbon, so that yellow is thermally transferred to the recording paper first. Then, the recording paper is run in a reverse direction to locate a start portion, so that cyan may be thermally transferred on yellow. Further, the recording paper is moved in the opposite direction to locate a start portion, so that magenta is thermally transferred on cyan, and by repeating the process, the thermal transfer can be performed onto the recording paper in the order of yellow, cyan, magenta, and the laminate film.

Next, in the print system 1 to which the present invention is applied, a procedure will be described in which the printing image data is read from the removable recording medium brought by the user, the printing image data to be printed is selected from the read printing image data, and the print areas with the plurality of printing sizes are simultaneously displayed on the selected printing image data.

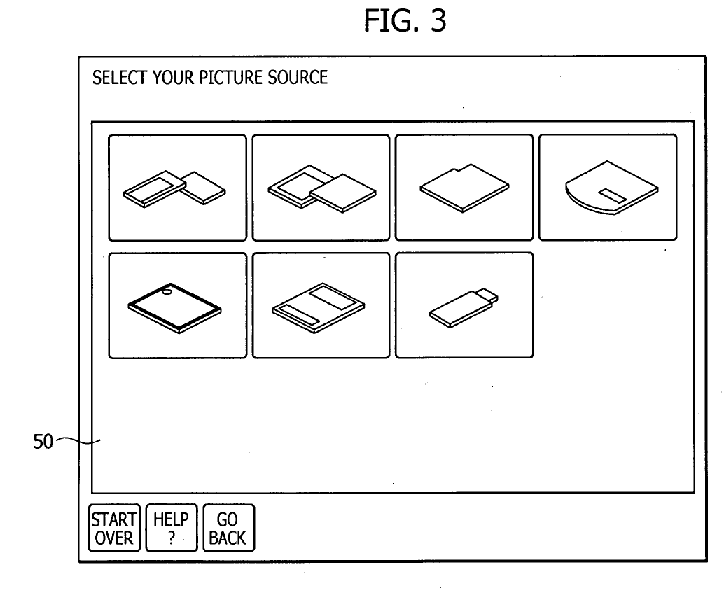

As for the image display apparatus 10, a standby screen (not shown) is displayed on the display part 15a of the touch panel 15 in an operation standby state. When a start button displayed on this standby screen is touched, a media selection screen 50 as shown in FIG. 3 is displayed.

As shown in FIG. 3, the media selection screen 50 is a screen for selecting a medium for reading the printing image data and the printing data, and can specify the medium by touching icons illustrating the USB memory, the optical disc, and various memory card which are respectively mounted to the USB flash memory I/F 11, the optical disc drive 12, and the memory card reader 13.

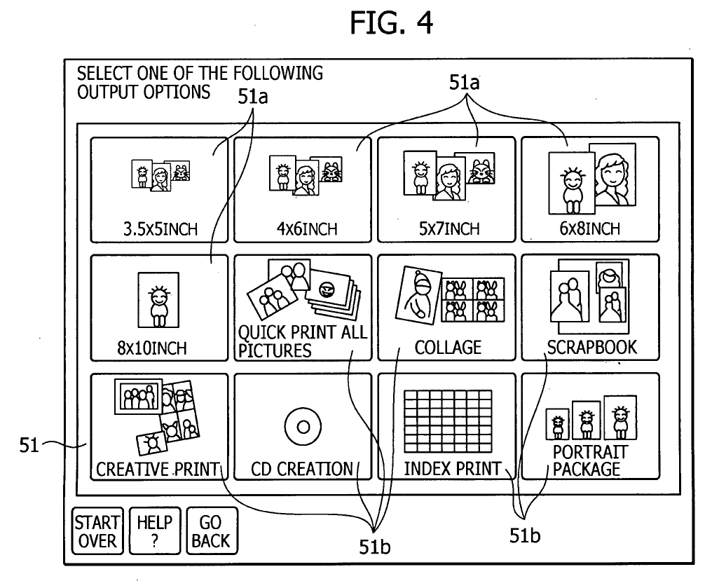

As the medium for reading the printing image data is specified, a printing menu screen 51 as shown in FIG. 4 is displayed on the display part 15a. The printing menu screen 51 as shown in FIG. 4 is for selecting a printing method of the read printing image data, and displays printing size selection icons 51a, such as 3.5×5 inches, 4×6 inches, 5×7 inches, 6×8 inches, 8×10 inches, etc., and special menu icons 51b, such as “Quick Print All Pictures”, “Collage”, “Scrapbook”, “Creative Print”, “CD Creation”, “Index Print”, “Portrait Package”, etc., for example.

The printing size selection icons 51a are icons for determining the printing sizes. The control unit 21 sets up the selected size as a default size. The selected printing image data is subjected to printing with the default size set up by the printing size selection icon 51a, unless the user changes any of the sizes for the printing image data.

Among these special menu icons 51b, the “Quick Print All Pictures” icon is set up so that all of the read printing image data may be printed. Further, by cutting off a part or all of the read printing image data and pasting the data to other read printing image data, the “Collage” icon edits so that one printing image may be constituted. Further, the “Scrapbook” icon cuts off a part of the read printing image data, and carries out various edits, such as pasting the cut data on one printing screen together with other printing image data to perform printing.

Further, among other special menu icons 51b, the “Creative Print” icon subjects each printing image data to edit, such as “Collage”, “Scrapbook”, etc. as described above. Furthermore, the “CD Creation” icon aimed to record the printing image data on the optical discs, such as CD-R. Still further, the “Index Print” icon displays by list and prints all the printing image data. Further, the “Portrait Package” icon prints the selected one printing image data in a plurality of printing sizes.

In addition, “Start Over” icon for returning to an initial screen, “Help?” icon used in the case of uncertain operation, and “Go Back” icon for returning to the media selection screen 50 are displayed on the printing menu screen 51. It should be noted that, the sizes of these printing size selection icons 51a and a menu of the special menu icons 51b can be added, changed, and removed as appropriate.

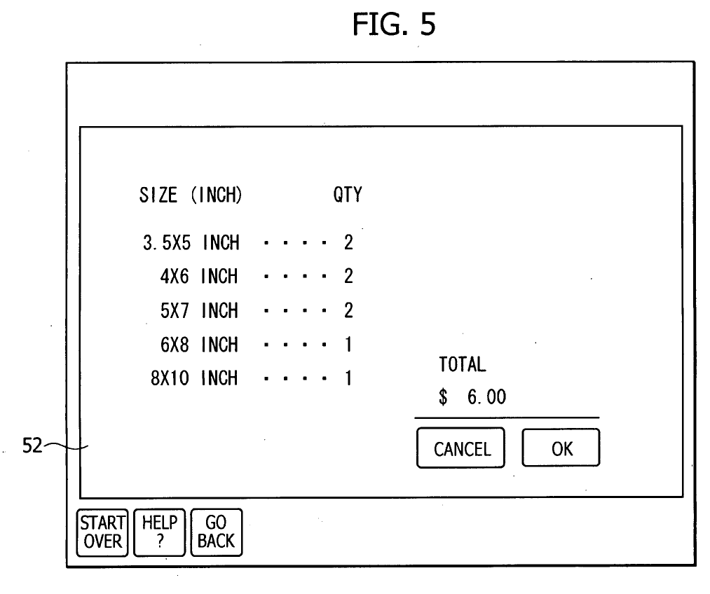

When the “Portrait Package” icon of the special menu icons 51b is touched, the control unit 21 moves the display of the touch panel 15 to a portrait contents confirmation screen 52 as shown in FIG. 5. As shown in FIG. 5, a plurality of printing sizes for printing the selected printing image data, the number of printing sheets for each of the printing sizes, and charges are displayed on the portrait contents confirmation screen 52.

It should be noted that neither the printing sizes nor the number of printing sheets are limited to those shown in FIG. 5, and can be added, changed and deleted as appropriate. Further, it is possible to change the size and the number into another package in which a combination of the printing sizes and the number of printing sheets differs, which is enabled when the user performs change operation on the portrait contents confirmation screen 52.

In addition, the “Start Over” icon for returning to the initial screen, the “Help?” icon used in the case of uncertain operation, and the “Go Back” icon for returning to the printing menu screen 51 are displayed on the portrait contents confirmation screen 52.

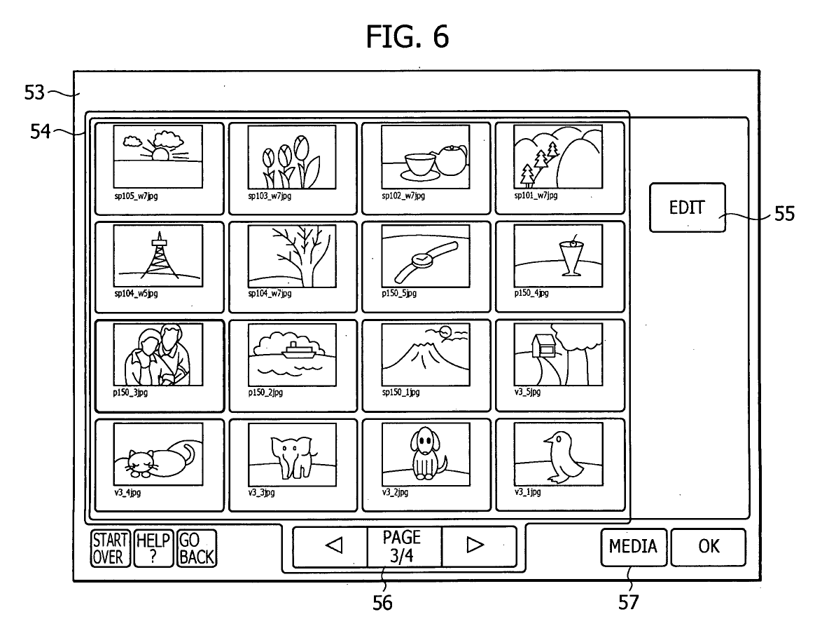

When the user confirms the contents of the portrait and touches an “O.K.” icon, the control unit 21 shifts the display of the touch panel 15 to the printing image selection screen 53 as shown in FIG. 6. As shown in FIG. 6, a thumbnail image display part 54 with which the printing image data is displayed by using a thumbnail image, an edit icon 55 for shifting the printing image data regarding the selected thumbnail image display to the edit image for editing, a page scroll icon 56 for scrolling a page when the printing image selection screen 53 is of a plurality of pages, and a media selection icon 57 for reading the printing image data from other media are displayed on the printing image selection screen 53.

In addition, the “Start Over” icon for returning to the initial screen, the “Go Back” icon for returning to the portrait contents confirmation screen 52, and the “Help?” icon used in the case of uncertain operation are displayed on the printing image selection screen 53.

The control unit 21 reads the printing image data stored in the removable storage medium selected previously to the thumbnail image display part 54 in order to display the data by using a thumbnail image, and stores the data in the image memory 16. Further, as for the thumbnail image display part 54 as shown in FIG. 6, the control unit 21 reads the printing image data from the image memory 16 and displays the data by using the thumbnail image at the thumbnail image display part 54 in a predetermined order, such as in order of recent photography date, for example.

In addition, in the case where printing data, such as DPOF (Digital Print Order Format) (registered trademark) with respect to the printing image data, is created in the memory card, it is possible that the control unit 21 also reads the printing data, preferentially displays, by using the thumbnail image, the printing image data in which the printing data is created. Thus, the user can peruse from the printing image data whose possibility of printing is high, and can efficiently find the printing image data to be printed out of the enormous printing image data stored in the memory card.

As described above, in the case where the printing image data is displayed by using the thumbnail image and the user touches and selects the thumbnail image of the printing image data to be printed, then a thumbnail image display frame of the selected printing image data is displayed thicker than others, or a background color of the display frame is changed etc to enter a selection state. When the “OK” icon is touched in this state, the control unit 21 shifts the display of the touch panel 15 to an order confirmation screen (to be described later but not shown).

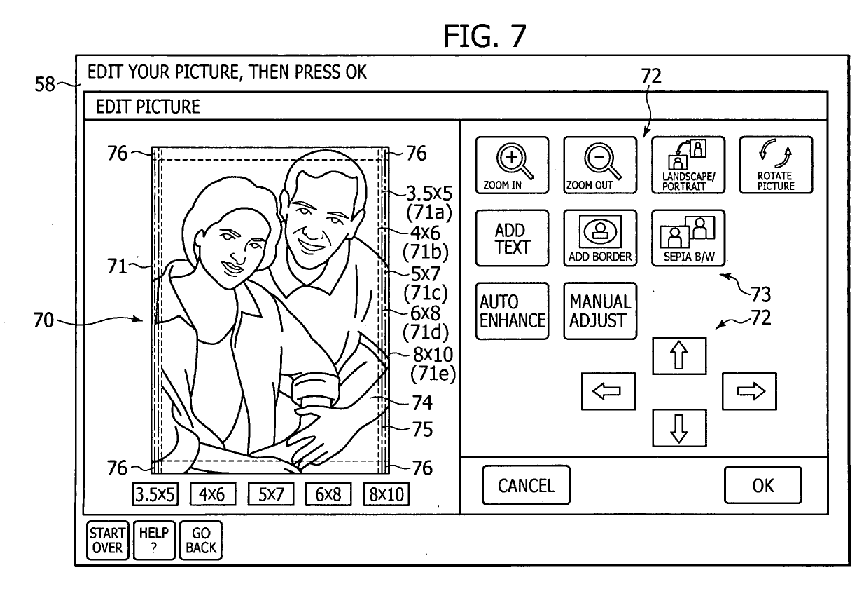

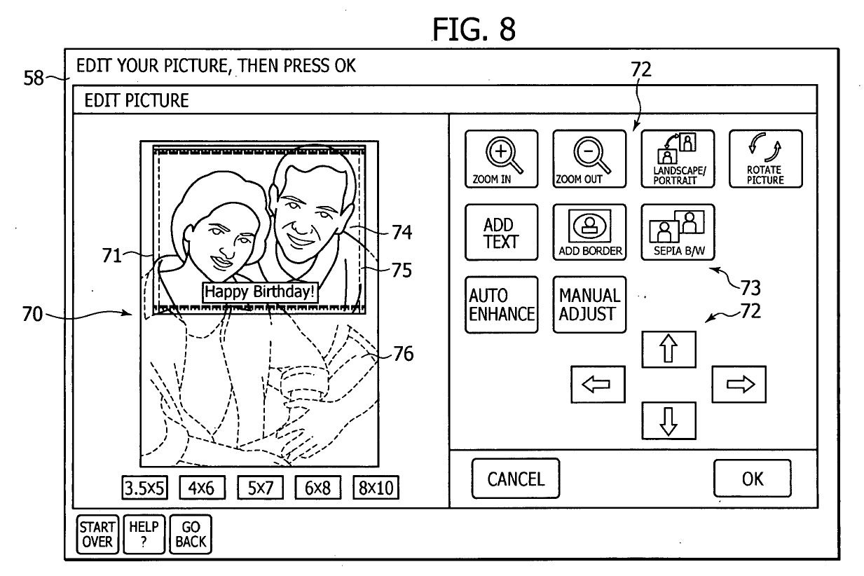

Further, in order that the user confirms the print area of each printing size for the selected printing image data, or when the user edits the printing image data, if the thumbnail image of the printing image data to be edited is touched and selected and the “edit” icon is touched, then the control unit 21 shifts the display of the touch panel 15 to the printing image edit screen 58 as shown in FIGS. 7 and 8.

As shown in FIGS. 7 and 8, the printing image edit screen 58 displays a photograph display part 70 for displaying the printing image data selected on the printing image selection screen 53, print area frames 71 for displaying print areas with a plurality of printing sizes on the selected printing image data, print area edit icons 72 for editing the print areas of printing sizes, such as “Zoom In”, “Zoom Out”, “Landscape portrait”, “Rotate picture”, “Up, Down, Left, and Right”, etc., and printing image edit icons 73 for editing the selected printing image data, such as “Add Text”, “Add Border”, “Sepia B/W”, “Auto Enhance”, “Manual Adjust”, etc.

The printing image data selected at the printing image selection screen 53 is displayed on the photograph display part 70. Print area frames 71a, 71b, 71c, 71d, and 71e showing the print areas of the printing sizes, for example 3.5×5 inches, 4×6 inches, 5×7 inches, 6×8 inches, and 8×10 inches, are displayed on this printing image data. (Hereafter, the print area frames 71a, 71b, 71c, 71d, and 71e may be simply referred to as print area frame 71).

These print area frames 71 have a different printing size. In the case where the selected printing image data is displayed on the photograph display part 70, they are simultaneously displayed on the printing image data displayed, on the photograph display part 70 while maintaining aspect ratios. Accordingly, by seeing the photograph display part 70, the user can confirm at a glance the print area with each printing size for printing the selected printing image data, and can also understand the print area relationships among the printing sizes easily.

Furthermore, each of the print area frames 71 is displayed in a different color, so that the user can confirm each print area at a glance. For example, the 3.5×5 inch print area frame 71a is displayed in white color, the 4×6 inch print area frame 71b is displayed in green color, the 5×7 inch print area frame 71c is displayed in red color, the 6×8 inch print area frame 71d is displayed in blue color, and the 8×10 inch print area frame 71e is displayed in yellow color.

It should be noted that the print area frame 71 is not limited to be displayed in colors as described above. As far as the user can confirm each print area at a glance, any color may be used and changed as appropriate. Further, the print area frames 71 are not limited to be displayed in different colors, and may be displayed by different kinds of lines, such as a solid line, a dotted line, dot-dash lines, etc, as long as the user may confirm each print area at a glance. Furthermore, the above-described colors and lines may be combined to display the print area frame 71 so that the user may confirm each print area easily at a glance.

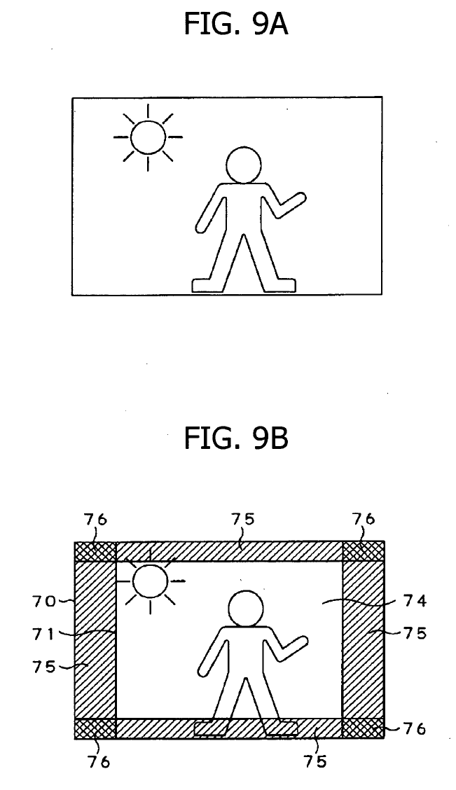

Further, the print area frames 71 are displayed simultaneously on the printing image data displayed on the photograph display part 70, while maintaining the aspect ratios. When trying to print the printing image data as shown in FIG. 9(A) in a plurality of printing sizes, aspect ratio of each printing size is different. Therefore, the printing image data includes a sharing print area 74 printed in any printing size, non-sharing print areas 75 (other than the sharing print area 74) printed in any one or more of the printing sizes, and a non-print area 76 which is not printed in any one of the print sizes, as shown in FIG. 9(B).

While the sharing print area 74 is displayed in the same image color as that of the printing image data, the non-sharing print area 75 is displayed in an image color which is thinner than that of the sharing print area 74. Thus, visibility of the non-sharing print area 75 becomes lower than that of the sharing print area 74, and it becomes easy for a user to distinguish between the sharing print area 74 and the non-sharing print area 75, and the user can confirm each print area easily.

Further, the non-print areas 76 are displayed in the image color which is thinner than that of the non-sharing print area 75. Thus, visibility of the non-print area 76 becomes lower than that of the non-sharing print area 75, and it is easy for a user to distinguish between the non-sharing print area 75 and the non-print area 76, and the user can confirm each print area easily.

It should be noted that the non-print area 76 may be displayed in the image color of substantially the same thickness as that of the non-sharing print area 75. Thus, the visibility of the non-sharing print area 75 and the non-print area 76 becomes lower than that of the sharing print area 74, it becomes easy to distinguish the sharing print area 74 from the non-sharing print area 75 and the non-print area 76, and the user can confirm each print area easily.

Further, as described above, the printing image data is not limited to confirming each print area by displaying one area with thinner image than that of another area, lowering the visibility of one area, and distinguishing each area. The printing image data may be such that the non-sharing print area 75 and the non-print area 76 are converted into single color images in a predetermined color, such as sepia, monochrome, etc., thickness of a predetermined color is differentiated for each area, visibility of the areas is differentiated, and the areas are distinguished, to confirm each print area easily.

Furthermore, the printing image data may be displayed such that the non-print area 76 is painted out with a predetermined color, for example, the background color of the photograph display part 70, so that the user can not view the non-print area 76. Accordingly, the user can distinguish easily the non-sharing print area 75 from the non-print area 76, and can confirm each print area easily.

Further, the printing image data may be arranged such that the non-print area 76 is not displayed on the photograph display part 70, and the user can not view the non-print area 76. Thus, the user can distinguish the non-sharing print area 75 from the non-print area 76, and can confirm each print area easily.

Furthermore, the printing image data may be displayed by differentiating the thickness of the image color for each non-sharing print area 75 with a printing size, and converted into a single color image in a predetermined color, such as sepia, and monochrome, so that the thickness of the predetermined color is differentiated for each non-sharing print area 75 with a printing size, whereby the visibility is differentiated for each non-sharing print area with a printing size to distinguish the non-sharing print area 75 with a printing size, thus becoming easy to confirm the non-sharing print area 75 with each printing size.

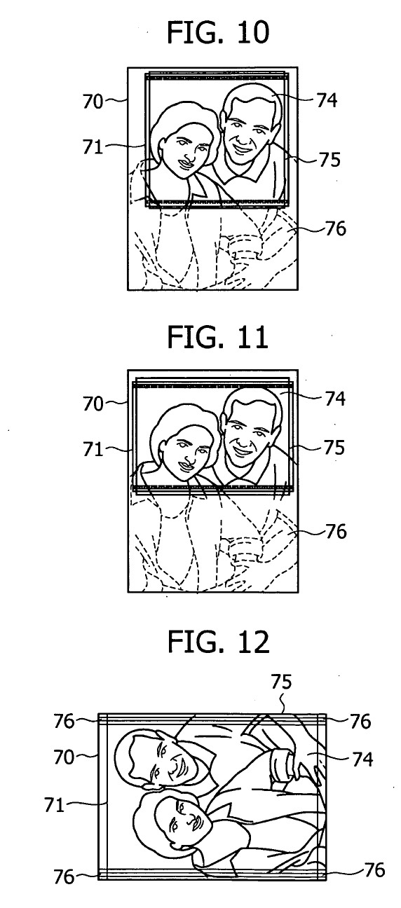

Among the print area edit icons 72, the icon of “Zoom In” is for enlarging the selected printing image data and the icon of “Zoom Out” is for reducing the selected printing image data. When the “Zoom In” icon is touched, the control unit 21 reduces the print area frame 71 inversely proportionally to a ratio at which the selected printing image data is enlarged, and displays the reduced print area frame 71 on the printing image data, as shown in FIG. 10. In particular, when the user wishes to print the selected printing image data by doubling the size, the control unit 21 reduces the print area frame 71 to half while maintaining the aspect ratio of each printing size, and displays the print area frame 71 reduced to half on the printing image data. Similarly, when the “Zoom Out” icon is touched, the control unit 21 enlarges the print area frame 71 according to the reduction ratio of the selected printing image data, and displays the enlarged print area frame 71 on the printing image data. Thus, the user can confirm the plurality of print areas at a glance also with respect to the printing image data which is displayed in an enlarged manner or in a reduced manner, and can perceive the relationships among the different print areas easily.

Further, the icon of “Landscape portrait” is for rotating the print area frame 71. In the case where the “Landscape portrait” icon is touched, each time the icon is touched, the control unit 21 rotates the print area frame 71 clockwise or counter-clockwise by 90 degrees (for example) with respect to the printing image data as shown in FIG. 11. Further, the icon of “Rotate picture” is for rotating the selected printing image data, as shown in FIG. 12. When the “Rotate picture” icon is touched, the control unit 21 rotates the printing image data, and rotates the print area frame 71 in the same direction according to the extent by which the printing image data is rotated. Further, the “Up, Down, Left, and Right” icon is for moving the print area frame 71, the text data to be described later, or various frames vertically and horizontally with respect to the printing image data. When the “Up, Down, Left, and Right” icon is touched, the control unit 21 slightly moves the print area frame 71, the text data, or various frames in the touched icon direction with respect to the printing image data.

Among the printing image edit icons 73, the “Add Text” icon performs edit of adding text data, such as a character and a date, to the selected printing image data. Further, the “Add Border” icon is for setting up the selected printing image data so that a circumference of the printing image may be decorated using the templates, such as various frames. Furthermore, the “Sepia B/W” icon is for converting the selected printing image data into sepia tone or monochrome tone. The “Auto Enhance” icon is for correcting the selected printing image data automatically. Still further, by means of the “Manual Adjust” icon, the user corrects manually the selected printing image data.

Even when editing the printing image data selected by using the above-described print area edit icons 72 and the printing image edit icons 73, the print area frames 71 for the respective printing sizes are simultaneously displayed on the selected printing image data at the photograph display part 70 as shown in FIG. 8. Thus, the user can edit the printing image data displayed on the photograph display part 70, while perceiving the print area with each printing size. Further, the user can edit the plurality of printing sizes for printing the selected printing image data by editing the selected printing image data.

In addition, the “Start Over” icon for returning to the initial screen, the “Help?” icon used in the case of uncertain operation, and the “Go Back” icon for returning to the printing image selection screen 53 are displayed on the printing image edit screen 58.

In the printing image edit screen 58, when the edit for the selected printing image data is completed and the “OK” icon in the lower right screen is touched, then the control unit 21 stores the printing image data after edit in the image memory 16, closes the printing image edit screen 58, and shifts a screen to the order confirmation screen (not shown)

In the order confirmation screen, the control unit 21 displays the printing size for printing the printing image data after edit, the printing number of sheets for each printing size, and a total amount of money. When the OK button is touched on this order confirmation screen, the printing image data after edit is transmitted to the printer apparatus 30, and printing data is generated by the control unit of the printer apparatus based on the printing image data. Then, based on the printing data, the printer apparatus 30 drives the thermal head 31, the ink ribbon drive 34, and the recording paper feeding unit 35, and prints a photograph according to the printing image data after edit on the papers with the plurality of sizes.

The print system 1 having the above-described structure, reads the printing image data from the removable recording medium brought by the user, selects the printing image data to be printed from the read printing image data, and simultaneously displays the print area frames 71 with the plurality of printing sizes on the selected printing image data, whereby the print areas with the plurality of printing sizes for printing the selected printing image data can be confirmed easily, and the relationships of the print areas among each printing sizes can also be perceived easily. Further, the print system 1 can perform the edit process for the selected printing image data, while perceiving the print areas of the plurality of printing sizes for printing the selected printing image data. Furthermore, the print system can edit the plurality of printing sizes for printing the selected printing image data by performing the edit process for the selected printing image data.

It should be noted that the present invention is not limited only to the above-described embodiments, and various modifications are possible without departing from the gist of the present invention. For example, in the present embodiments, the description is carried out with reference to the hardware structure, but the present invention is not limited thereto. It is possible to realize any process by causing a CPU (central-processing-unit) to execute a computer program, which may alternatively be provided and transmitted through transmission media, such as the Internet etc.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-262658 filed in the Japanese Patent Office on Oct. 5, 2007, the entire content of which being incorporated herein by reference.

What is claimed is:

1. A print system for printing one printing image data in a plurality of printing sizes, the print system comprising:
an image display apparatus for displaying the printing image data, and
a printer apparatus for printing the one printing image data which is displayed and selected with the image display apparatus in a plurality of printing sizes, wherein;
the image display apparatus includes;
record means in which the printing image data is stored,
display means for displaying the printing image data stored in the record means, and
control means for causing the display means to simultaneously display frame data in the plurality of printing sizes on the selected printing image data.

2. The print system according to claim 1, wherein;
the control means prints the edited printing image data in the plurality of printing sizes when the printing image data is edited.

3. The print system according to claim 2, wherein;
when the printing image data is zoomed, the control means displays frame data with the plurality of printing sizes in enlarged or reduced manner which is at same proportional with a zoom ratio.

4. The print system according to claim 2, wherein;
when the printing image data is rotated, the control means rotates the frame data with the plurality of printing sizes in the same direction according to the degree at which the printing image data is rotated.

5. The print system according to claim 1, wherein;
the frame data with the plurality of printing sizes are formed in different colors according to the printing sizes.

6. The print system according to claim 1, wherein;
the frame data with the plurality of printing sizes are formed with different kinds of lines according to the printing sizes.

7. The print system according to claim 1, wherein;
the printing image data includes;
a sharing print area printed in any printing size, and a non-sharing print area printed in any one or more of the printing sizes, and
the non-sharing print area is displayed with lower visibility than that of the sharing print area.

8. The print system according to claim 7, wherein;
the non-sharing print area is displayed in an image color which is thinner than that of the sharing print area.

9. The print system according to claim 8, wherein;
the non-sharing print area is displayed by differentiating thickness for each of the printing sizes.

10. The print system according to claim 7, wherein;
the printing image data further includes a non-print area which is not printed in any one of the printing sizes, and
the non-print area is displayed with substantially the same visibility as that of the non-sharing print area or with visibility lower than that of the non-sharing print area.

11. The print system according to claim 10, wherein;
the non-print area is displayed in the image color of substantially the same thickness as that of the non-sharing print area or displayed in an image color which is thinner than that of the non-sharing print area.

12. The print system according to claim 10, wherein;
the non-print area is not displayed on the display means.

13. An image display apparatus for displaying one printing image data printed in a plurality of printing sizes by a printer apparatus, the image display apparatus comprising:
record means in which the printing image data is stored,
display means for displaying the printing image data stored in the record means, and
control means for causing the display means to simultaneously display frame data in the plurality of printing sizes on the selected printing image data.

14. An image display method for an image display apparatus for displaying one printing image data to be printed in a plurality of printing sizes by a printer apparatus, the image display method comprising the steps of:
displaying the printing image data stored in record means on display means, and
causing the display means to simultaneously display the frame data in the plurality of printing sizes on the selected printing image data.

15. An image display program product for causing a control computer of an image display apparatus which displays one printing image data to be printed in a plurality of printing sizes by a printer apparatus, to execute the processing of:
displaying the printing image data stored in record means on display means, and
causing the display means to simultaneously display frame data in a plurality of printing sizes on the selected printing image data.
